(19) United States
(12) Patent Application Publication
(10) Pub. No.: US 2011/0074362 A1
(43) Pub. Date: Mar. 31, 2011

(54) BATTERY UNIT

(75) Inventor: Makoto MIDORIKAWA, Tokyo (JP)

(73) Assignee: KABUSHIKI KAISHA TOSHIBA, Tokyo (JP)

(21) Appl. No.: 12/894,033

(22) Filed: Sep. 29, 2010

(30) Foreign Application Priority Data
Sep. 30, 2009 (JP) 2009-228903

(51) Int. Cl. H02J 7/00; H01M 10/50

(52) U.S. Cl. 320/150; 429/7

(57) ABSTRACT

A battery unit includes: a case; a circuit board configured to be provided in the case; a battery cell configured to be provided in the case and an endothermic reaction occurs during charging and an exothermic reaction occurs during discharging therein; a heat generating component configured to be provided on the circuit board; and a heat transferring member configured to be thermally connected with the heat generating component and the battery cell, and to transfer heat generated by the heat generating component to the battery cell.

### CROSS-REFERENCE TO RELATED APPLICATION

This application is based on and claims priority under 35 U.S.C. §119 from Japanese Patent Application No. 2009-228903 filed on Sep. 30, 2009, the entire contents of which are incorporated herein by reference.

### BACKGROUND

1. Field

The present invention relates to a battery unit capable of an improvement in heat dissipation efficiency.

2. Description of the Related Art

In recent years, there is devised a battery capable of being charged with a large current as compared with a commonly used lithium-ion battery (hereinafter referred to as a new type battery). Since the new type battery has specifications which allow charging by passing a current larger than that for the lithium-ion battery, as a result, it becomes possible to charge the new type battery up to a fully charged condition in a time period shorter than that for the lithium-ion battery.

In the new type battery of this type, since a large current as compared with the lithium-ion battery is passed during the charging, it follows that an element or the like in a charging circuit generates heat. Consequently, it is necessary to provide a heat dissipation mechanism for the new type battery to suppress the heat generation of the charging circuit.

As a method for cooling a battery during the charging of a secondary battery, JP-A 2004-208470 discloses a charger in which a cooling unit surrounding the secondary battery is provided to absorb a rise in battery temperature occurring during the charging of the secondary battery. An object thereof is to provide the charger which can efficiently perform fast charging in a short time period while suppressing the rise in battery temperature during the fast charging by providing such a structure.

In the technique described in JP-A 2004-208470, the cooling unit surrounding the battery is provided. However, in a case where especially the cooling unit of the type which circulates a coolant (liquid) is provided, it becomes necessary to newly provide a waterproof mechanism. Since this method results in an increase in the size of the battery and an increase in cost due to the provision of the waterproof mechanism, a new mechanism for cooling the secondary battery is desired.

### BRIEF DESCRIPTION OF THE DRAWINGS

A general architecture that implements the various features of the invention will now be described with reference to the drawings. The drawings and the associated descriptions are provided to illustrate embodiments of the invention and not limited the scope of the invention.

FIG. 1 is a perspective view showing an outer appearance of a battery unit according to an embodiment of the present invention;

FIG. 2 is a perspective view showing an internal structure of the battery unit according to the embodiment of the present invention;

FIG. 3 is a cross-sectional view showing the internal structure of the battery unit according to the embodiment of the present invention; and

FIG. 4 is a block diagram showing a system structure of the battery unit according to the embodiment of the present invention.

### DETAILED DESCRIPTION OF THE EMBODIMENTS

Various embodiments according to the invention will be described hereinafter with reference to the accompanying drawings.

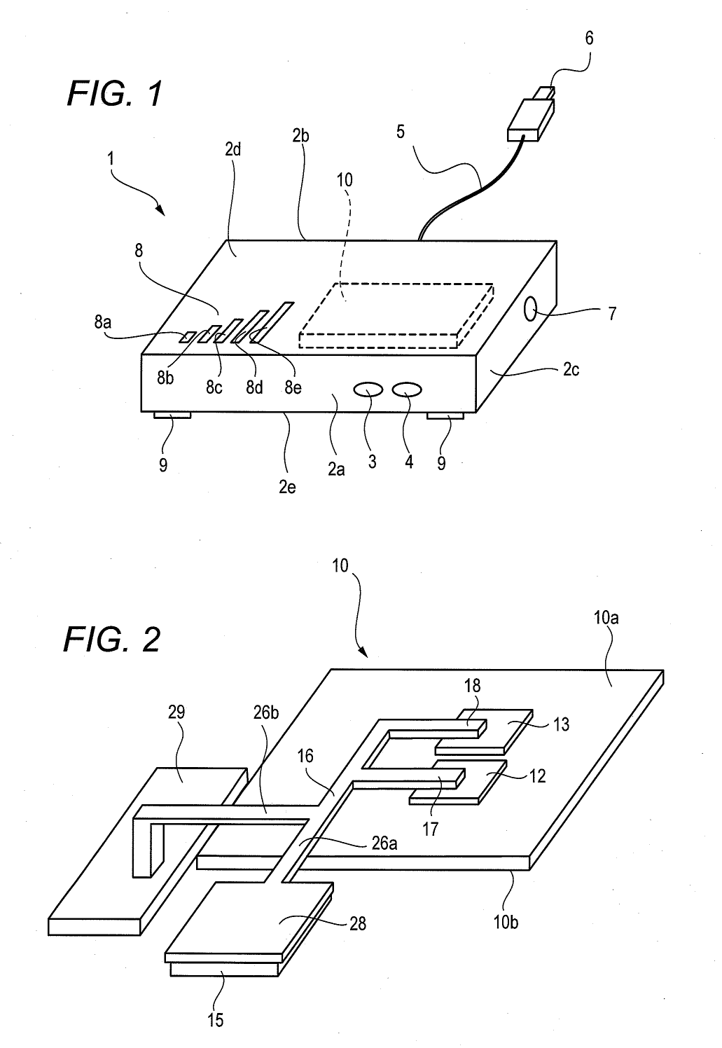

FIG. 1 is a perspective view showing an outer appearance of a battery unit according to the embodiment of the present invention. A battery unit 1 includes a main body case 2. On a front face 2a of the main body case 2, switches 3 and 4 each for operating the battery unit 1 are provided. These switches can be used as, e.g., power switches for turning on the power of the battery unit 1. From a back face 2b of the battery unit 1, a USB cable 5 is extended. At the tip of the USB cable 5, a USB connector 6 for the connection with electronic equipment such as a computer or the like is provided. By connecting the USB connector 6 with a USB port provided in the electronic equipment such as the computer or the like, it is possible to supply power from the battery unit 1 to the electronic equipment.

On a side face 2c of the main body case 2, a DC-IN jack 7 is provided. By an AC adaptor which is not shown, alternating current power inputted from a commercial power source is converted to direct current power. A DC plug of the AC adaptor is inserted into the DC-IN jack 7 to supply power to the battery unit 1. The battery unit 1 uses the supplied power to perform the charging of a battery cell in the battery unit 1.

On an upper face 2d of the main body case 2, an indicator 8 is provided. The indicator 8 can be formed of five LEDs of an LED 8a, an LED 8b, an LED 8c, an LED 8d, and an LED 8e. By the number of LEDs caused to light up among these five LEDs of the LED 8a, the LED 8b, the LED 8c, the LED 8d, and the LED 8e, the remaining amount of the battery of the battery unit 1 can be indicated.

On a bottom face 2e of the main body case 2, leg parts 9 for supporting the main body case are provided. Inside the main body case 2, a circuit board 10 is provided.

As the difference between a conventional lithium-ion battery and the new type battery, specific figures will be presented as an example. When the charging of the conventional lithium-ion battery is performed, it is assumed that a current of 1.8 A can be passed. At this time, the charging is performed by passing the current of 1.8 A for two hours with respect to the capacity of the lithium-ion battery of 4000 mAh, and the battery is thereby charged up to 3600 mA (900).

On the other hand, as disclosed in the embodiment of the present invention, since the new type battery capable of being charged with a large current when compared with the lithium-ion battery has specifications which allow the charging by passing the current larger than that for the lithium-ion battery, as a result, it becomes possible to charge the battery up to the fully charged condition in a time period shorter than that for the lithium-ion battery.

When the charging of the new type battery is performed, it is assumed that the current of 21.6 A can be passed. At this time, since the charging is performed by passing the current of 21.6 A with respect to the capacity of the new type battery of 4000 mAh, the battery is charged up to 3600 mA (90%) in only 10 minutes. The charging performed in a relatively short time period by passing a large current is occasionally referred to as fast charging for convenience sake in the present embodiment.

In the new type battery of this type, since the large current is passed during the charging when compared with the lithium-ion battery, it follows that an element or the like of a charging circuit generates heat. Consequently, it is necessary to provide a heat dissipation mechanism for the new type battery to suppress the heat generation of the element or the like of the charging circuit.

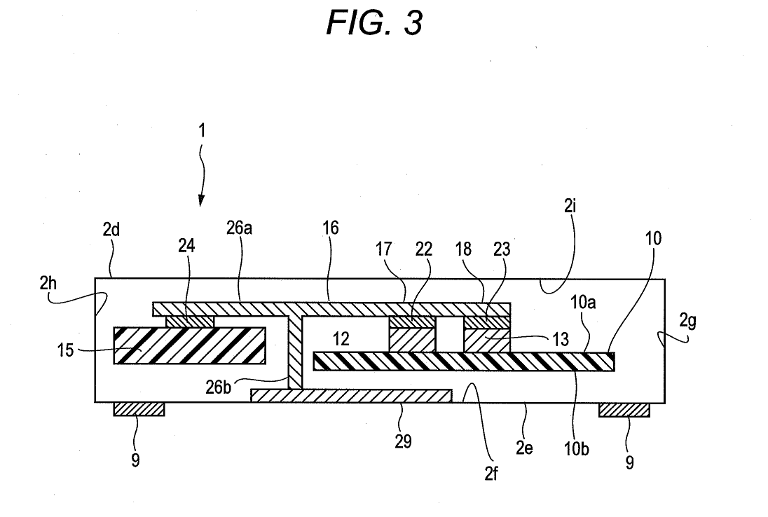

FIG. 2 is a perspective view showing an internal structure of the battery unit according to the embodiment of the present invention. FIG. 3 is a cross-sectional view showing the internal structure of the battery unit according to the embodiment of the present invention. A description will be given of the heat dissipation mechanism provided inside the battery unit by using FIGS. 2 and 3.

Inside the battery unit 1, the circuit board 10 is provided and, on an upper face 10a of the circuit board 10, electronic components such as a charging circuit 12 and a processor 13 are mounted. The charging circuit 12 is an electronic component which generates heat by its own operation. Similarly, the processor 13 is also the electronic component which generates heat by its own operation. In the present embodiment, the charging circuit 12 and the processor 13 which generate heat by their own operations are occasionally referred to as heat generating components.

As has been described above, a battery cell 15 is a battery compatible with the fast charging capable of performing the charging in a relatively short time period by passing the large current. When the fast charging of the battery cell 15 of the present embodiment is performed, especially the charging circuit 12 generates heat. Accordingly, it is necessary to provide the heat dissipation mechanism for the heat generating components such as the charging circuit 12 and the processor 13 to suppress the heat generation of the heat generating components.

Inside the battery unit 1, a heat sink 16 is provided. The heat sink 16 includes a first heat receiving part 17 which abuts the charging circuit 12 to receive heat from the charging circuit 12, and a second heat receiving part 18 which abuts the processor 13 to receive heat from the processor 13.

Between the charging circuit 12 and the first heat receiving part 17, a heat conductive member 22 such as silicon grease or a heat conductive sheet is provided. In addition, between the processor and the second heat receiving part 18, a heat conductive member 23 is also provided.

The heat sink 16 transfers heat received from the charging circuit 12 and the processor 13 via the first and second heat receiving parts 17 and 18. The heat sink 16 is branched into heat transferring parts 26a and 26b on a heat transferring path.

The heat transferring part 26a is connected with a first heat dissipating member 28. The first heat dissipating part 28 is thermally connected with the battery cell 15 and, between the first heat dissipating member 28 and the battery cell 15, a heat conductive member 24 is provided. The battery cell 15 is a secondary battery in which an endothermic reaction occurs during the charging and an exothermic reaction occurs during discharging. During the charging of the battery cell 15, the heat generating components such as the charging circuit 12 and the processor 13 generate heat but, by thermally connecting the heat generating components with the battery cell 15 using the heat sink 16, the endothermic reaction during the charging of the battery cell 15 can be utilized for the heat dissipation.

In general, as the amount of current passed for the charging of the battery cell 15 increases, the amount of heat generated by the charging circuit 12 increases. However, since the endothermic reaction during the charging of the battery cell 15 concurrently progresses, it is considered that the endothermic reaction during the charging of the battery cell 15 can be adequately utilized.

In contrast to the case where the heat is only dissipated naturally by an air cooling using the first heat dissipating member 28, by utilizing the endotherm as a chemical reaction occurring during the charging of the battery cell 15, the heat dissipation efficiency of the battery cell 15 can be improved.

The heat transferring part 26b is connected with a second heat dissipating member 29. With the provision of the second heat dissipating member 29, the heat dissipation efficiency can be further improved to a level higher than that of the heat dissipation utilizing the battery cell 15 and the first heat dissipating member 28.

In the present embodiment, the second heat dissipating member 29 is provided so as to contact an inner face 2f of the main body case 2. The inner face 2f is positioned on the opposite side of the bottom face 2e. The second heat transferring part 26b extending from the heat sink 16 is bent once in a region off the circuit board 10, extends in a direction from the upper face 10a of the circuit board 10 toward a lower face 10b, and abuts the second heat dissipating member 29.

The second heat dissipating member 29 may be provided at an arbitrary position inside the main body case 2 but, in general, by providing the second heat dissipating member 29 on any of the inner face 2f of the main body case 2, an inner face 2g, an inner face 2h, and an inner face 2i, the heat dissipation efficiency is further improved. In addition, by providing the second heat dissipating member 29 especially on the inner face 2f positioned on the opposite side of the bottom face 2e of the battery unit 1, the position of the second heat dissipating member 29 can be displaced from the position at which a user holds the battery unit 1 with his or her hand.

Normally, is difficult to provide a cooling fan inside the battery unit or an air hole for cooling in the case of the battery unit. Thus, in accordance with the battery unit according to the present embodiment, it is possible to efficiently perform the heat dissipation using the endotherm as the chemical reaction occurring during the charging of the battery cell, and the heat dissipation utilizing a heat pipe, the heat transferring members, and the heat dissipating members.

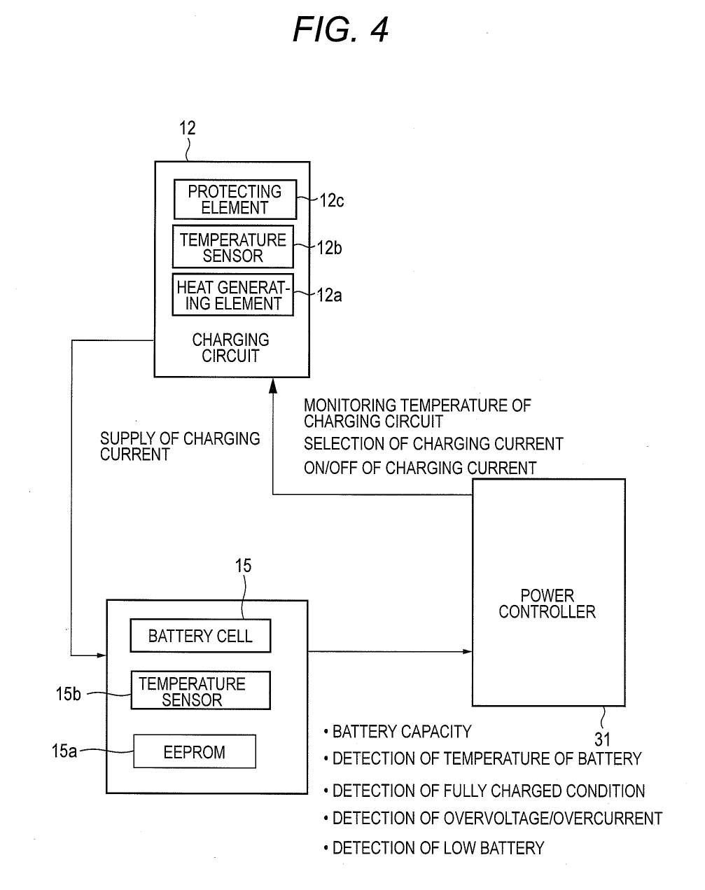

FIG. 4 is a block diagram showing a system structure of the battery unit according to the embodiment of the present invention. The battery unit 1 is formed of various parts in addition to parts shown in FIG. 4. However, in FIG. 4, a description is given by extracting the parts particularly related to the description of the embodiment of the present invention and omitting other parts.

The charging circuit 12 supplies a current for the charging with respect to the battery cell 15. The charging circuit 12 includes a heat generating element 12a which generates heat when the charging of the battery cell 15 is performed. The charging circuit 12 also includes a temperature sensor 12b for detecting a temperature of the charging circuit 12. The temperature sensor 12b detects a rise in temperature caused by the heat generation of the elements themselves such as an FET and a resistor in the charging circuit 12 resulting from the operation of the charging circuit 12. A value of the temperature detected by the temperature sensor 12b is used for the control of the charging current passed by the charging circuit 12.

The charging circuit 12 also includes a protecting element 12c represented by, e.g., a fuse in order to secure the safety of the charging circuit 12 and the battery unit 1.

Inside the battery unit 1, an EEPROM 15a for storing information on the battery cell 15 is provided. Inside the battery unit 1, a temperature sensor 15b for detecting the temperature of the battery cell 15 is also provided.

The battery cell 15, the EEPROM 15a, and the temperature sensor 15b may be separately provided inside the battery unit 1. Further, the battery cell 15, the EEPROM 15a, and the temperature sensor 15b may be brought together into one battery pack, and the battery pack may also be mounted inside the battery unit 1.

The system of the battery unit 1 can read the information on the battery cell 15 from the EEPROM 15a via a power controller 31.

In the EEPROM 15a, there is stored the information related to the battery cell 15, i.e., ID information on the battery cell 15, the capacity of the battery cell 15, a parameter related to charging control such as a completion current value when the battery cell 15 is fully charged, and information for indicating that the battery cell 15 is a battery compatible with the fast charging.

The power controller 31 performs the control of the charging circuit 12 based on the information read from the EEPROM 15a.

In addition to the acquisition of the ID information on the battery cell 15, the capacity of the battery cell 15, the parameter related to the charging control of the battery cell 15, and the information for indicating that the battery cell 15 is a battery compatible with the fast charging which have been mentioned in the above description, the power controller 31 can detect the temperature of the battery cell 15, that the battery cell 15 is fully charged, that overvoltage/overcurrent occurs in the battery cell 15, and that the battery cell 15 is in a low-battery state where the capacity thereof is lower than a given threshold value.

The power controller 31 reads the temperature of the charging circuit 12 from the temperature sensor 12b of the charging circuit 12. The power controller 31 selects the charging current for charging the battery cell 15 to send the instruction for ON/OFF of the charging current to the charging circuit 12 based on the information read from the EEPROM 15a and the value of the temperature indicated by the temperature sensor 12b of the charging circuit 12.

For the protection of the battery cell 15 and the charging circuit 12 inside the battery unit 1, and for the safety of the user using the battery unit 1, threshold values are individually set for the temperature of the battery cell 15 and the temperature of the charging circuit 12. When the temperature of the battery cell 15 exceeds the threshold value, or when the temperature of the charging circuit 12 exceeds the threshold value, the control is performed by the power controller 31 such that the charging operation with respect to the battery cell 15 is suspended or the charging current supplied to the battery cell 15 is reduced.

The charging current supplied to the battery cell 15 may be minutely changed in accordance with the values of the temperatures detected by the temperature sensors 12b and 15b. Alternatively, when both of the values of the temperatures detected by the temperature sensors 12b and 15b do not exceed the threshold values, the charging of the battery cell 15 may be performed by passing the large current, while the charging of the battery cell 15 may be performed by passing the current of the order of a few A which is lower than the large current when at least one of the temperatures detected by the temperature sensors 12b and 15b exceeds the threshold value.

As has been described above, according to the embodiment of the present invention, it is possible to provide a battery unit capable of an improvement in heat dissipation efficiency.

The present invention is not limited to the above-described embodiment and can be variously modified without departing from the gist thereof.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A battery unit comprising:
a case;
a circuit board in the case;
a battery cell in the case that is configured to have therein an endothermic reaction during charging and an exothermic reaction during discharging;
a heat generating component on the circuit board; and
a heat transferring member thermally connected with the heat generating component and the battery cell, and to transfer heat generated by the heat generating component to the battery cell.

2. The battery unit of claim 1 further comprising:
a heat dissipating member in the case, wherein
the heat transferring member is further configured to transfer the heat generated by the heat generating component to the heat dissipating member.

3. The battery unit of claim 2 further comprising:
a charging circuit configured to control the charging of the battery cell;
a first temperature sensor configured to detect a temperature of the battery cell; and
a second temperature sensor configured to detect the temperature of the heat generating component, wherein
the charging circuit is configured to reduce a charging current, when at least one of the temperature of the battery cell detected by the first temperature sensor and the temperature of the heat generating component detected by the second temperature sensor exceeds a predetermined threshold value.

4. The battery unit of claim 3, wherein
the heat dissipating member is provided in contact with an inner face of the case.

5. The battery unit of claim 4, wherein
the heat dissipating member is in contact with the inner face of the case and is positioned on a bottom face of the case.

6. A battery unit comprising:
a case which comprises a circuit board therein;
a battery cell in the case and in which an endothermic reaction occurs during charging and an exothermic reaction occurs during discharging;
a charging circuit on the circuit board, to control the charging of the battery cell and to generate heat during the charging of the battery cell;
a heat dissipating member in the case; and
a heat transferring member thermally connected with the battery cell and the heat dissipating member from the charging circuit, and to transfer heat generated by the charging circuit to the battery cell and the heat dissipating member.

7. The battery unit of claim 6 further comprising:
a first temperature sensor configured to detect a temperature of the battery cell; and
a second temperature sensor configured to detect the temperature of a heat generating component, wherein
the charging circuit is configured to reduce a charging current, when at least one of the temperature of the battery cell detected by the first temperature sensor and the temperature of the heat generating component detected by the second temperature sensor exceeds a predetermined threshold value.
